(19) United States
(12) Patent Application Publication
(10) Pub. No.: US 2012/0176376 A1
(43) Pub. Date: Jul. 12, 2012

(54) METHOD AND SYSTEM FOR DISPLAYING ELECTRIC FIELD INFORMATION AND PORTABLE TERMINAL SUPPORTING THE SAME

(75) Inventors: Kwang Young Kim, Suwon-si (KR); Hyo Jin Kim, Suwon-si (KR)

(73) Assignee: SAMSUNG ELECTRONICS CO., LTD., Suwon-si (KR)

(21) Appl. No.: 13/346,691

(22) Filed: Jan. 9, 2012

(30) Foreign Application Priority Data
Jan. 10, 2011 (KR) 10-2011-0002180

(51) Int. Cl. G06T 15/00; G08C 19/16

(52) U.S. Cl. 345/419; 340/870.01

(57) ABSTRACT

A method, a system, and portable terminal display electric field information. The method includes collecting a sensor signal including location information and direction information of a portable terminal, transmitting the collected sensor signal to an information providing server, and receiving and outputting electric field information indicating an electric field intensity between the portable terminal and at least one base station located within a predetermined range of a direction in which the portable terminal is arranged among the at least one base station arranged around the portable terminal based on the sensor signal by the portable terminal.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Jan. 10, 2011 and assigned Serial No. 10-2011-0002180, the contents of which are incorporated herein by reference.

### TECHNICAL FIELD OF THE INVENTION

The present invention relates to display of electric field information of a portable terminal, and more particularly, to a method and a system for displaying electric field information capable of actively providing electric field information of base stations providing a communication service to a portable terminal, and a portable terminal supporting the same.

### BACKGROUND OF THE INVENTION

In recent years, a portable terminal has been used to very wide fields based on mobility. In particular, a mobile communication terminal may have various functions including a function for transmitting/receiving call information between speakers as a main function. For example, a conventional portable terminal may have an MP3 function corresponding to a file playback function and an image collecting function corresponding to a digital camera capable of collecting images. Further, the conventional portable terminal supports a function capable of performing a mobile game or an arcade game. So as to support the foregoing various functions in a portable terminal, a region of a display unit has been enlarged and high performance hardware is mounted thereon to load the various function.

The foregoing conventional portable terminal should transmit and receive a signal of a suitable strength to and from a base station to operate a suitable communication service. When the portable terminal cannot transmit and receiving the signal of a suitable strength, it cannot support a communication service. To express such a situation, the conventional portable terminal displays strength of a signal transmitted and received to and from a current base station. However, because information on a location which should be occupied by the user is unsuitable to make the signal strength excellent and the signal strength is displayed without considering the mobility of a conventional portable terminal, the conventional portable terminal is no help to the users for improving the signal strength. In particular, when the strength of a signal becomes weak while a user grips the portable terminal and moves, it is convenient for the user to reversely set a moving direction to improve the strength of a corresponding signal.

### SUMMARY OF THE INVENTION

To address the above-discussed deficiencies of the prior art, it is a primary object to provide a method and a system for displaying electric field information that allow a user to operate a communication service in an excellent electric field situation by outputting electric field information of base stations according to a moving direction, peripheral images and an altitude of a portable terminal, and a portable terminal supporting the same.

In accordance with an aspect of the present disclosure, a method for displaying electric field information includes: collecting a sensor signal including location information and direction information of a portable terminal; transmitting the collected sensor signal to an information providing server by the portable terminal; generating electric field information indicating an electric field intensity between the portable terminal and a least one base station located within a predetermined range of a direction in which the portable terminal is arranged among at least one base station arranged around the portable terminal based on the sensor signal by the information providing server; and receiving and outputting the electric field information by the portable terminal.

In accordance with another aspect of the present disclosure, a system for displaying electric field information includes: an information providing server generating at least one of two-dimensional electric field information indicating an electric field intensity between the portable terminal and at least one base station located within a predetermined range of a direction in which the portable terminal is arranged among at least one base station arranged around the portable terminal based on a first sensor signal including location information and direction information received from the portable terminal, and three-dimensional electric field information based on augmented reality indicating an electric field intensity between at least one base station and the portable terminal based on a second sensor signal including the location information, the direction information, altitude information, and image information received from the portable terminal; and the portable terminal collecting and transmitting the first and second sensor signals to the information providing server, and receiving and outputting at least one of the two-dimensional electric field information and the three-dimensional electric field information from the information providing server.

In accordance with another aspect of the present disclosure, a portable terminal supporting display of electric field information includes: a sensor including a direction detection sensor detecting the direction information and a location detection sensor detecting the location information; a radio frequency communication unit transmitting a sensor signal collected from the respective detection sensors to an information providing server, and receiving two-dimensional electric field information indicating an electric field intensity between the portable terminal and at least one base station located in a predetermined range within an arranged direction of the portable terminal indicated by the direction information among at least one base station arranged around the portable terminal from the information providing server; a display unit displaying the current location of the portable terminal, a location of at least one base station located in a peripheral zone of a path moved in a moving direction of the portable terminal and a peripheral zone of an expected moving path, and an electric field intensity between the portable terminal and the at least one base station displayed on a zone neighboring a point on which the at least base station is displayed on map information of a peripheral zone based on the current location of the portable terminal; and a controller controlling transmission of the sensor signal, and reception and output of the electric field information.

The sensor further comprises an altitude detection sensor for collecting altitude information and an image collecting sensor for collecting image information; the radio frequency communication unit transmitting the altitude information and the image information to the information providing server according to an input signal, and receiving electric field information based on three-dimensional augmented reality including information of objects including at least one base station in an image included in image information based the location information, the direction information, the altitude information, and the image information of the portable terminal from the information providing server; and the display unit displays image information based on augmented reality of a direction in which the image detection sensor of the portable terminal is arranged among image information of a peripheral zone based on the current location of the portable terminal, and information of objects including at least one base station among the images based on augmented reality and information including an electric field intensity between the at least one base station and the portable terminal according to an input signal.

A method and a system for displaying electric field information and a portable terminal supporting the same may guide a user to a direction capable of receiving a suitable electric field signal according to various peripheral situations and environments such as variations in a moving direction or an altitude of the portable terminal to efficiently support a communication service and to reduce battery power consumption under an excellent electric field situation.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a system for displaying electric field information according to the present disclosure;

FIG. 2 illustrates a configuration of a portable terminal according to the present disclosure;

FIG. 3 illustrates a configuration of a controller shown in FIG. 2 in detail;

FIG. 4 illustrates an example of a two-dimensional electric field information display screen interface according to the present disclosure;

FIG. 5 illustrates an example of a three-dimensional electric field information display screen interface according to the present disclosure;

FIG. 6 illustrates another example of a three-dimensional electric field information display screen interface according to the present disclosure; and

FIG. 7 illustrates a method for displaying electric field information according to the present disclosure.

### DETAILED DESCRIPTION OF THE INVENTION

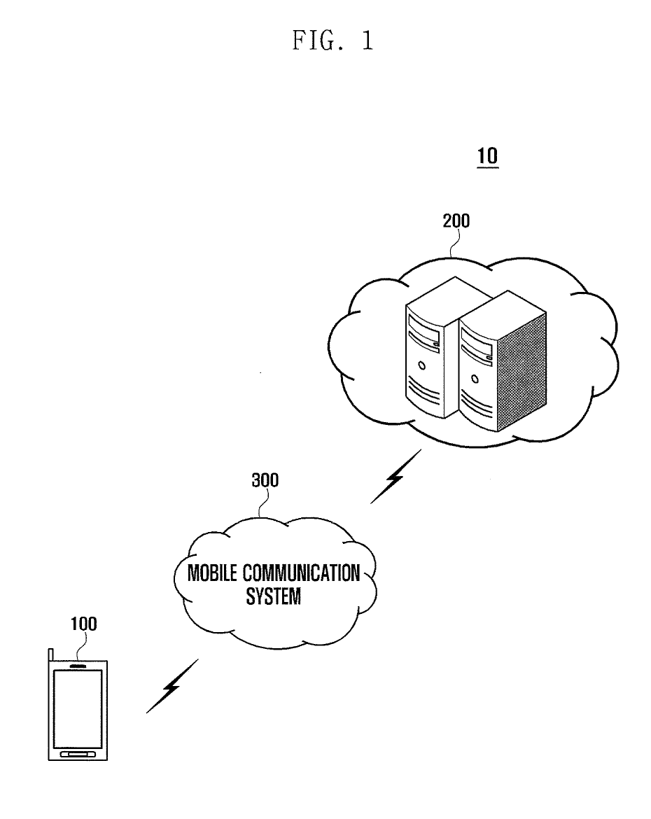

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications network. Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

FIG. 1 illustrates a schematic configuration of a system for displaying electric field information according to the present disclosure.

Referring to FIG. 1, the system 10 for displaying electric field information according to an exemplary embodiment of the present disclosure may include a portable terminal 100, a mobile communication system 300, and an information providing server 200.

In the system 10 for displaying electric field information, if the portable terminal 100 provides its state information such as current location information, moving direction information, altitude information, and image information to the information providing server 200, the information providing server 200 searches base station information of a located zone of the portable terminal 100 and produces electric field information based on the searched base station information, a distance between a base station and the portable terminal 100, and wireless communication coverage information of base stations. If the information providing server 200 provides the produced electric field information to the portable terminal 100, the system 10 may output electric field information received by the portable terminal 100 that allows a user to easily recognize peripheral electric field information of the portable terminal 100. The system allows the user to easily move from a current location to a direction capable of improving an electric field situation. The electric field information may be information indicating an intensity of the electric field between the portable terminal and at least one base station located within a predetermined range of a direction which the portable terminal 100 is arranged among a plurality of base stations disposed at a periphery of the portable terminal 100.

Hereinafter, functions and roles of respective structural elements will be described in detail.

The mobile communication system 300 supports signal transmission and reception between the portable terminal 100 and the information providing server 200. The mobile communication system 300 may include a plurality of base stations, a base station controller managing respective base stations, and a service center managing the base station controller. The service center may support switching of signals transmitted or received by the portable terminal 100. In particular, the mobile communication system 300 may provide state information received from the portable terminal 100 to the information providing server 200, and relay electric field to be transferred to the portable terminal 100 from the information providing server 200. The mobile communication system 300 supports signal transmission and reception according to a certain communication scheme to communicate with the portable terminal 100. In this example, the certain communication scheme may change according to a design of the mobile communication system 300 and a communication module of the portable terminal 100, and may be designed to support various communication schemes such as CDMA, GSM, WCDMA, Wireless Broadband Internet (Wibro), Wireless-Fidelity (Wi-Fi), or HSDPA.

Base stations included in the wireless communication system 300 are arranged at various zones to overlap a predetermined part of communication coverage, and may include various types of base stations to support a wireless environment. Base stations included in the mobile communication system 300 according to an embodiment of the present disclosure may include micro-miniature base stations such as a base station relay, Femto cell, Ubi cell as well as large base stations directly connecting with a base station controller. The service center may manage and store location information with respect to respective base stations and wireless coverage information of the respective base stations, and transfer corresponding wireless coverage information to the information providing server 200.

The information providing server 200 creates electric field information of the present disclosure to display the electric field information. The information providing server 200 produces peripheral electric field information of a corresponding portable terminal based on state information provided from the portable terminal 100 through a connection with the mobile communication system 300. In this example, the information providing server 200 produces electric field information to which a corresponding electric field situation is applied based on stored map information. Substantially, the information providing server 200 may connect with a service center of the mobile communication system 300 or be included in the service center. The information providing server 200 may be separately configured by a certain server connecting with the mobile communication system 300 through Internet or Intranet. The information providing server 200 may determine whether the portable terminal 100 registers in a corresponding service as a member to support a service for providing the electric field information.

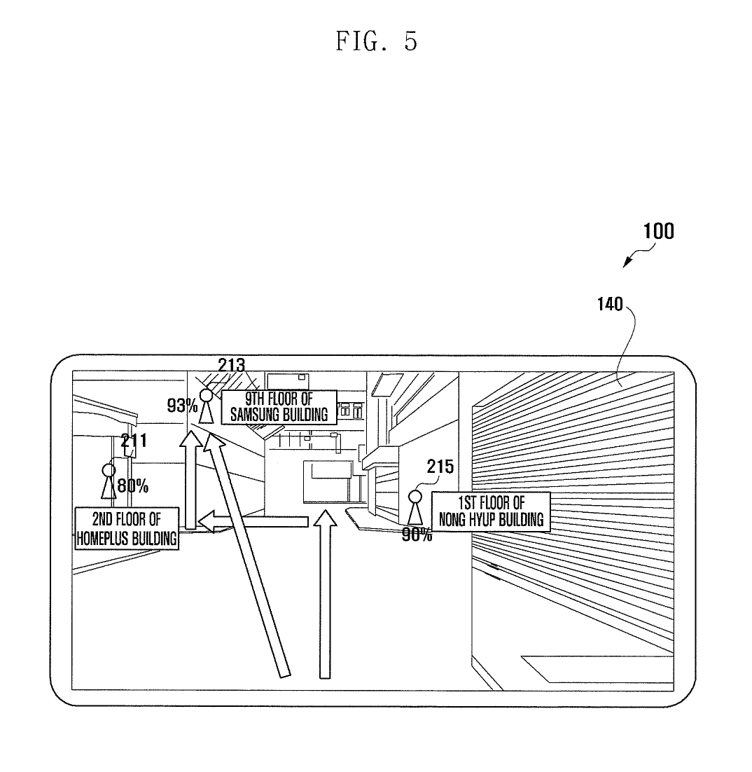

Further, the information providing server 200 may apply state information provided from the portable terminal 100 to augmented reality to create electric field information. The augmented reality is a service that matches information of various objects such as buildings, roads, other art objects arranged in a real environment and a corresponding environment of a located zone of the portable terminal 100 and provides the information. The information providing server 200 may exactly provide real locations of various base stations, in particular, micro-miniature base stations arranged in the real environment in application of the augmented reality to suitably move the portable terminal in a wireless coverage of a base station, thereby improving an electric field situation in a current location of the portable terminal 100. A procedure of providing electric field information based on augmented reality will be described with reference to FIG. 5 in detail.

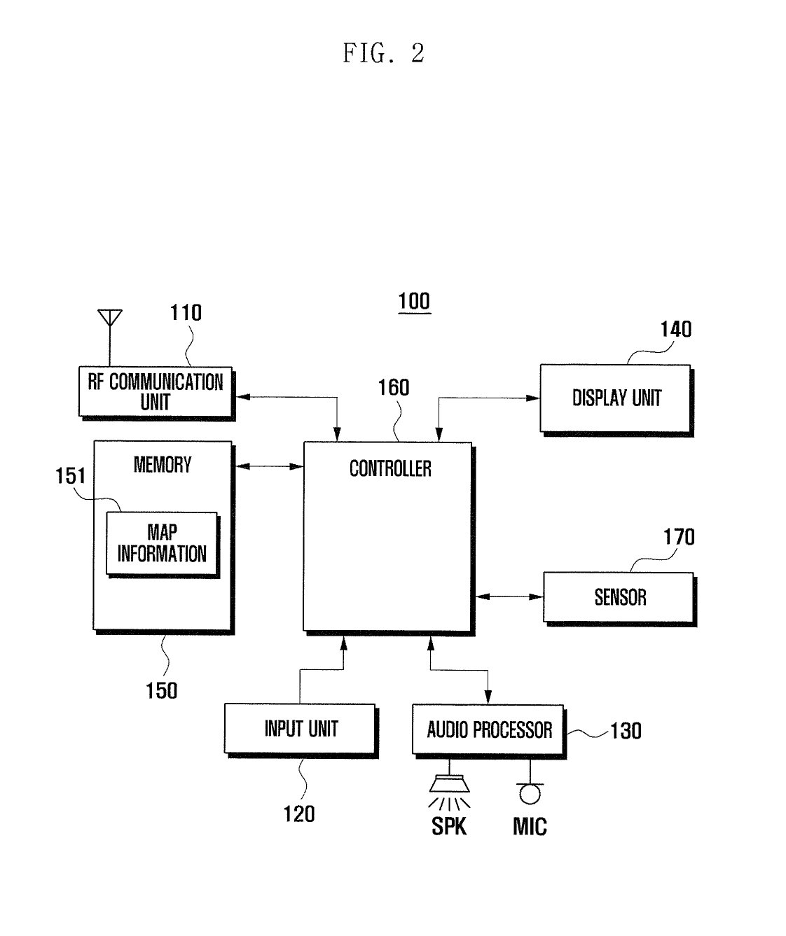

The portable terminal 100 transmits state information containing location information, direction information, altitude information, and image information to the information providing server 200. Further, the portable terminal 100 receives and outputs peripheral electric field information corresponding to the state information such that the user may easily recognize a peripheral electric field information situation and control a moving direction and an altitude capable of improving an electric field situation during a movement. A detail construction of the portable terminal 100 will be illustrated with reference to FIG. 2 in detail.

As illustrated above, the system for displaying electric field information according to an embodiment of the present disclosure may support to acquire a more excellent electric field situation while a portable terminal 100 is moving, and to improve a suitable electric field situation in an electric field situation having a great deviation according to an altitude in the same location.

FIG. 2 illustrates a configuration of a portable terminal 100 according to the present disclosure.

Referring to FIG. 2, a portable terminal 100 of the present disclosure may include a radio frequency (RF) communication unit 110, an input unit 120, an audio processor 130, a display unit 140, a memory 150, a sensor 170, and a controller 160.

The portable terminal 100 of the present disclosure having a construction as described above may collect various sensor information associated with the portable terminal 100 using the sensor 170, convert the collected sensor information into state information, and transmit the converted state information to the information providing server 200 through the mobile communication system 300 so as to support an electric field information display service of the present disclosure. Further, the portable terminal 100 may output electric field information received corresponding to the state information from the information providing server 200 through the display unit 140 and temporarily store the received electric field information in the memory 150. Receiving and output functions of the electric field information of the portable terminal 100 may be performed in real time or with a predetermined time period, and changed according to moving speed of the portable terminal 100. Functions and roles of the respective structural elements of the portable terminal 100 will be described in detail.

The RF communication unit 110 forms a communication channel for a voice call, a communication channel for a videophone call, or a communication channel for transmitting data such as images or messages under the control of the controller 160. That is, the RF communication unit 110 forms a voice call channel, a data communication call channel, and a videophone call channel between mobile communication systems 300. To do this, the RF communication unit 110 may include a transmitter up-converting a frequency of a transmitted signal and amplifying the signal, a receiver low-noise-amplifying a received signal and down-converting the signal. In particular, the RF communication unit 110 of the present disclosure may transmit state information created based on sensor information collected by the sensor 170 to the information providing server 200 through the mobile communication system 300 according to a user request. Further, the RF communication unit 110 may receive electric field information provided from the information providing server 200 through the mobile communication system 300 and transfer the received electric field information to the controller 160.

In this example, the RF communication unit 110 may differently form a communication channel created according to an electric field information display mode of the portable terminal. For example, when an electric field information display mode of the portable terminal 100 is set to a two-dimensional (2D) electric field information display mode, the RF communication unit 110 may form a message service channel with the mobile communication system 300 to provide state information containing only location information and direction information of the portable terminal 100 to the information providing server 200. Moreover, when the portable terminal 100 is set to an electrode field information display mode based on a 3D electric field information display mode, the RF communication unit 110 may form a data channel between mobile communication systems 300 to transmit state information containing location information, direction information, altitude information, and image information.

The input unit 120 includes a plurality of input keys and function keys for receiving input of numeral or character information and setting various types of functions. The function keys may include arrow keys, side keys, and hot keys set to perform certain functions. In particular, the input unit 120 of the present disclosure may create an input signal for activating a certain user function. In this example, when the certain user function is a function requiring communication service support, the portable terminal 100 may automatically support an electric field information output function when activating a corresponding user function. Further, the input unit 120 may create an input signal for setting a 2D electric field information display mode, an input signal for setting a 3D electric field information display mode, and an input signal for setting an electric field information display mode according to user setting. The input unit 120 may transfer the created input signal to the controller 160.

The audio processing unit 130 includes a speaker SPK outputting audio data transmitted or received during a call and audio data included in a message, and audio data stored in the memory 150; and a microphone MIC collecting a user's voice or other audio signals during the call. When receiving electric field information from the information providing server 200, the audio processor 130 may output audio data alarming the received electric field information. When outputting the electric field information, the audio processor 130 may output a guide sound with respect to electric field information of respective base stations for the portable terminal 100. The audio processor 130 may output information on a location of the nearest base station as audio data in a 3D electric field information display mode based on augmented reality. The output function of the audio data may be activated or inactivated according to user setting.

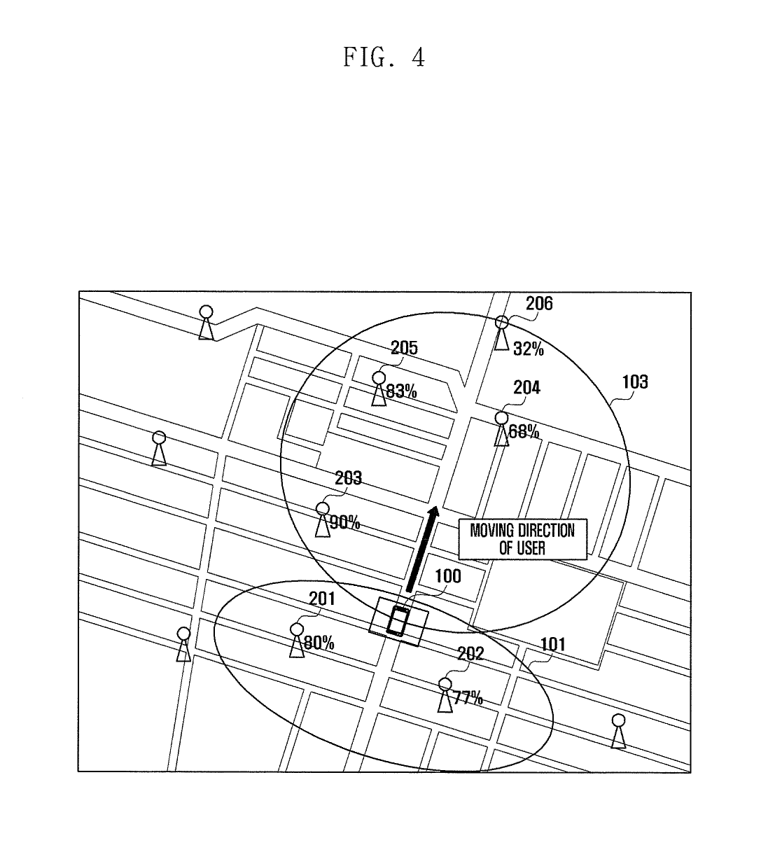

The display unit 140 displays information input by a user or information provided to the user as well as various types of menu of the mobile terminal. That is, the display unit 140 may provide various screens such as an idle screen, a menu screen, a message making screen, a call screen, and a mobile terminal booting screen according to utilization of the portable terminal 100. The display unit 140 may be configured by a form of a flat panel display such as a Liquid Crystal Display (LCD) or an Organic Light Emitted Diode (OLED). When the LCD or the OLED is configured by a touch screen type, the display unit 140 may be included in an input means. To do this, the display unit 140 may include a display panel and a touch sensor provided on the display panel, and support a function of a touch screen. In particular, when an electric field information display mode or a user function requiring display of electric field information is activated, the display unit 140 of the present disclosure may display electric field information associated with a current location of the portable terminal 100 at a predetermined region of a screen. In particular, the display unit 140 may output at least one of a 2D electric field information display screen or a 3D electric field information display screen according to user setting or a type of currently activated user function. The electric field information display screen will be explained with reference to FIG. 4 to FIG. 6 in detail. Meanwhile, when the sensor 170 is activated according to electric field information display mode support, the display unit 140 may output sensor information collected by the sensor 170 temporarily or for a required time of user. The display unit 140 may output a screen transmitting state information created based on the sensor information to the information providing server 200.

The memory 150 may store an application program necessary for a function operation according to an embodiment of the present disclosure, an application program for playing variously stored files, and a key map and a menu map for operating a corresponding touch screen when the portable terminal 100 uses a touch screen. In this example, the key map and the menu map may become various forms. That is, the key map may become a keyboard map, a 3*4 key map, a Qwerty key map, or a control key map for controlling an operation of a currently activated application program. Meanwhile, the menu map may become a menu map for controlling an operation of a currently activated application program or a menu map having various menus provided from the portable terminal 100 as an item. The memory 150 may chiefly include a program area and a data area.

The program area may store a program controlling an overall operation of the terminal 100, an operating system (OS) booting the terminal 100, an application program necessary for playback of multimedia contents, or other option functions of the terminal 100 such as a camera function, a sound playing function, or an image or moving image playing function. In particular, the program area of the present disclosure may store an electric field information output program.

If a certain user function requiring an electric field information output is activated or an input signal requesting the electric field information output is created, the electric field information output program is loaded into the controller 160 to support performing a function for the electric information output. To do this, the electric field information output program may a routine checking a currently set electric field information display mode when an electric field output is requested, a routine activating a sensor 170 to collect current location information and direction information when a 2D electric field information display mode is set, a routine performing a control operation to collect direction information, a routine activating the sensor 170 to collect current location information, direction information, altitude information, and image information when a 3D electric field information display mode based on augmented reality is set, a routine creating respective state information based on the collected sensor information, and a routine transmitting the created state information to the information providing server 200. When electric field information is received from the information providing server 200, the electric field information output program may include an output routine outputting the received electric field information to the display unit 140. In this example, the output routine may include a sub routine calling map information 151 stored in the memory 150 and a sub routine outputting corresponding electric field information on the called map information. Here, the information providing server 200 creates at least one of 2D electric field information and 3D electric field information according to a type of state information provided from the portable terminal 100, and transmits the created electric field information to a corresponding portable terminal 100.

The data area may store data created according to the use of the portable terminal and various contents. Moreover, when the display unit 140 is implemented by a touch screen, the data area may store a user input provided through the touch screen. In particular, the data area of the present disclosure may temporarily or semi-permanently store map information 151 and electric field information. In this example, the map information 151 may become information previously downloaded and stored from the information providing server 200 to process data more rapidly in an electric field information output procedure. The electric field information contains map information of a peripheral zone based on a located zone of the portable terminal 100, current location information of the portable terminal 100, moving direction information of the portable terminal 100, location information of a plurality of base stations arranged at a periphery of the portable terminal 100, wireless coverage information of respective base stations, and electric field intensity information between the respective base stations and the portable terminal 100. Further, when the electric field information is 3D electric field information based on augmented reality, it may contain data information regarding a real peripheral environment, and detailed location information of base stations in respective objects in a real environment.

The sensor 170 may include a plurality of sensors for collecting sensor information included in state information to be transmitted to the information providing server 200. That is, the sensor 170 may include a location detection sensor, an altitude detection sensor, a direction detection sensor, and an image collection sensor. Further, the sensor 170 may include a speed detection sensor for detecting moving speed of the portable terminal 100. For example, the sensor 170 may include a GPS sensor for detecting a location, an acceleration sensor and a gyro sensor for detecting a moving direction, and an altitude sensor and a geomagnetic sensor for detecting an altitude. A part of a plurality of sensors included in the sensor 170 may be activated according to the electric field information display mode. That is, when the portable terminal is in a 2D electric field information display mode, the location detection sensor and the direction detection sensor may be activated. When the portable terminal is in a 3D electric field information display mode, the location detection sensor, the altitude detection sensor, a direction detection sensor, and the image collecting sensor may be activated. Sensor signal collecting periods of respective sensors of the sensor 170 may be changed according to moving speed of the portable terminal 100.

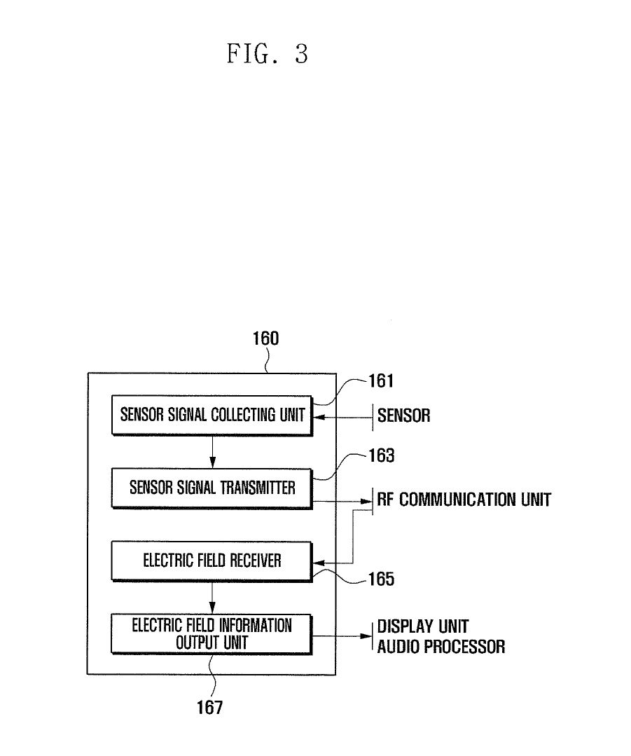

The controller 160 controls power supply to respective structural elements of the portable terminal 100 to perform an initialization procedure. If the initialization procedure is terminated, the controller 160 may control signal flow for supporting an electric field information display function of the present disclosure with respect to the respective structural elements. To do this, the controller 160 of the present disclosure may include structural elements as illustrated in FIG. 3.

FIG. 3 illustrates a configuration of a controller 160 shown in FIG. 2 in detail.

Referring to FIG. 3, the controller 160 of the present disclosure may include a sensor signal collecting unit 161, a sensor signal transmitter 163, an electric field information receiver 165, and an electric field information output unit 167. The sensor signal collecting unit 161 controls activation and inactivation of respective sensors included in the sensor 170, and collecting periods of sensor signals of the sensors. When the portable terminal 100 request a 2D electric field information display mode, as illustrated previously, the sensor signal collecting unit 161 controls the location detection sensor and the direction detection sensor to be activated, and controls corresponding sensors to transmit collected sensor signals to the sensor signal transmitter 163. Moreover, when the portable terminal 100 requests a 3D electric field information display mode, as illustrated earlier, the sensor signal collecting unit 161 controls the location detection sensor, the direction detection sensor, the altitude detection sensor, and the image collecting sensor to be activated, and performs a control operation to transmit the respective collected sensor signals to the sensor signal transmitter 163.

The sensor signal collecting unit 161 may perform a control operation to sense moving speed of the portable terminal 100 and to adjust collecting times of respective sensor signals according to variation in the moving speed. That is, when the moving speed of the portable terminal 100 is less than or equal to a predetermined value, the sensor signal collecting unit 161 performs a control operation so that the collecting periods of the sensor signal maintains a predetermined value. When the moving speed of the portable terminal 100 is increased, the sensor signal collecting unit 161 may apply a more frequent time period than a previous collecting period of the sensor signals to frequently collect the sensor signals. That is, when the moving speed of the portable terminal 100 is increased, the sensor signal collecting unit 161 performs a control operation to make the collecting periods of the sensor signals shorter. Conversely, when the moving speed of the portable terminal 100 is reduced, the sensor signal collecting unit 161 performs a control operation to make the collecting period of the sensor signals longer. If necessary, the sensor signal collecting unit 161 may collect the sensor signals in real time. Such a function supports such that the portable terminal 100 may rapidly and efficiently search peripheral base stations with more excellent electric field intensity of the portable terminal 100 according to moving speed.

The sensor signal transmitter 163 performs a control operation to convert sensor signal collected from the sensor signal collecting unit 161 into state information and to transmit the converted state information to the information providing server 200. In this example, as illustrated previously, the sensor signal transmitter 163 may perform a control operation to form a message service channel between mobile communication systems 300 or a data communication channel according to a currently set electric field information display mode. The sensor signal transmitter 163 may perform a control operation to form only a data communication channel between the mobile communication systems 300 and to transmit the state information to the information providing server 200 through the data communication channel.

The electric field information receiver 165 receives electric field information from the information providing server 200 through the RF communication unit 110. The electric field information receiver 165 forms a previously configured data communication channel or a data communication through the RF communication unit 110 according to a request from the information providing server 200, and receives electric field information provided from the information providing server 200 based on a corresponding data communication channel. In this example, the electric field information receiver 165 may previously receive peripheral map information 151 of the portable terminal 100 from the information providing server 200 to improve the mobility and data processing speed of the portable terminal 100, and receive electric field information of respective base stations associated with the portable terminal 100 to be marked on the peripheral map information. Accordingly, the electric field information receiver 165 may temporarily store the received map information 151 in the memory 150, and transfer newly received electric field information to the electric field information output unit 167. A receiving period of the electric field information received by electric field information receiver 165 may be changed according to the moving speed of the portable terminal 100, and the electric field information may be received in real time according to a user request or a policy of the information providing server 200.

The electric field information output unit 167 outputs the electric field information received by the electric field information receiver 165 to the display unit 140. When the map information 151 is stored in the memory 150, the electric field information output unit 167 applies the electric field information transferred to corresponding map information 151 to output it to the display unit 140. When no map information 151 is stored in the memory 150, the electric field information output unit 167 may receive map information provided from the information providing server 200 together with the electric field information, and output them to the display unit 140. In this example, if a current certain user function is activated to output a screen associated with a corresponding user function on the display unit 140, the electric field information output unit 167 may divide a screen and output the electric field information on the divided screen. The electric field information output unit 167 may output a separate screen or pop-up to include electric field information on the display unit 140. The electric field information output unit 167 may output electric field information of respective base stations through the audio processor 130. To do this, the information providing server 200 may create and transmit audio data with respect to the electric field information to the portable terminal 100.

As illustrated previously, a portable terminal 100 according to an embodiment of the present disclosure may output electric field information of peripheral base stations using the mobility of the portable terminal 100 according to user setting to acquire a more excellent electric situation on a moving line of the user, and display a more exact detailed location of corresponding base stations based on augmented reality to which altitude information and image information are applied to allow a user to easily track a base station.

Hereinafter, an electric field information output screen interface according to an embodiment of the present disclosure will be illustrated with reference to FIG. 4 to FIG. 6 in detail.

FIG. 4 illustrates an example of a two-dimensional electric field information display screen interface according to the present disclosure.

Referring to FIG. 4, a display unit 140 of the portable terminal 100 of the present disclosure displays map information 151, current location information of the portable terminal 100 on the map information 151, and location information of peripheral base stations 201, 202, 203, 204, 205, 206 based on the current location information of the portable terminal 100. The display unit 140 may further output moving direction information of the portable terminal 100 included in the electric field information on the map information 151. In this example, the display unit 140 may divide and display a predetermined region based on the moving direction information of the portable terminal 100. That is, the display unit 140 may display a peripheral zone 101 of a moved path including base stations 201 and 202 located in a zone through the portable terminal 100 passes and a peripheral zone 103 of an expected moving path including base stations 203, 204, 205, and 206 arranged at a periphery when the portable terminal 100 forward moves along a moving direction.

In particular, the display unit 140 of the present disclosure may output electric field intensity information currently providable to the portable terminal 100 to a zone neighboring a located point of respective base stations. In this example, the respective base stations 201, 202, 203, 204, 205, and 206 may substantially provide different electric field information to a portable terminal 100 according to characteristics of corresponding base stations. Typically, electric field intensity between a base station and the portable terminal 100 may be changed according to a distance or the performance of each base station. Accordingly, a relatively long distance base station may indicate a higher electric field intensity of the portable terminal 100. As illustrated above, the display unit 140 of the present disclosure may display electric field information of respective base stations that allows the user to acquire a more excellent electric field situation on a desired moving direction.

Meanwhile, the 2D electric field information display screen interface displays the same form of the base stations. However, the present disclosure is not limited thereto. That is, the display unit 140 may differently display corresponding icons or output a description associated with a corresponding base station according to characteristics of the respective base stations 201, 202, 203, 204, 205, and 206. For example, the display unit 140 may output different icon forms or different text information for a corresponding description to distinguish a general base station with a micro-miniature base station.

If a moving direction of the portable terminal 100 changes, a peripheral zone 103 of an expected moving path may be changed on map information 151 according to variation in a moving direction. When a certain zone in the map information 151 is selected as a peripheral zone 103 of a newly expected moving path, the display unit 140 may output electric field information of new base stations included on the peripheral zone 103 of a corresponding expected moving path according to electric field information provided from the information providing server 200.

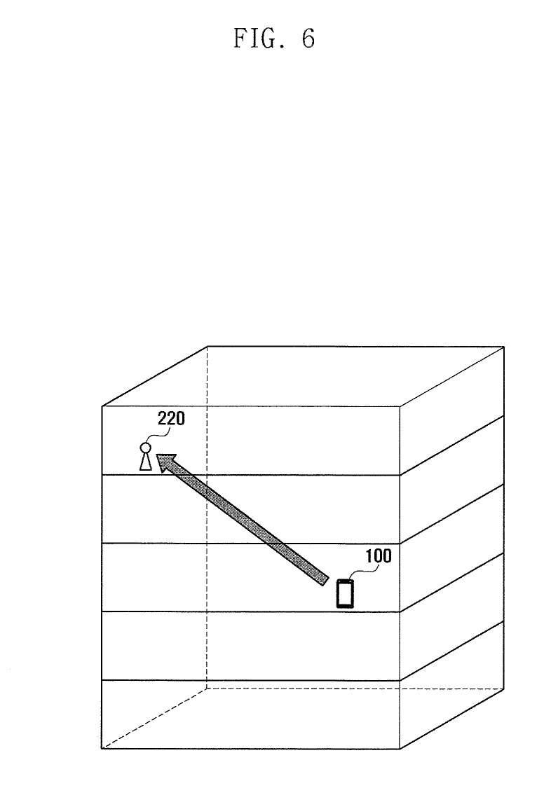

FIG. 5 illustrates an example of a three-dimensional electric field information display screen interface according to the present disclosure. FIG. 6 illustrates another example of a three-dimensional electric field information display screen interface according to the present disclosure.

Referring to FIG. 5, a display unit 140 of the present disclosure may output a 3D electric field information screen based on augmented reality according to a user request. To do this, the portable terminal 100 may activate a location detection sensor, a direction detection sensor, an altitude detection sensor, and an image detection sensor included in a sensor 170, and may provide state information included in collected sensor signals to an information providing server 200. Accordingly, the information providing server 200 detects total peripheral image information according to a current location of the portable terminal 100. Further, the information providing server 200 may detect partial image information of a direction that the portable terminal 100 faces based on direction information, and compensate for the detected partial image information to image on a height of a corresponding portable terminal 100 according to altitude information of the portable terminal 100. As illustrated above, the information providing server 200 may collect information about objects such as Homeplus building, Samsung building, and NongHyup building included in corresponding image information. The information providing server 200 may search base stations 211, 213, and 215 located in objects included in the corresponding image. In this example, the information providing server 200 may output distances between the portable terminal 100 and base stations 211, 213, and 215 located at certain points, namely, a certain location and a certain altitude of respective objects, and electric field intensity information according to wireless communication coverage zones of respective base stations 211, 213, and 215 to a zone neighboring located points of the respective base stations 211, 213, and 215. Further, the information providing server 200 may provide information about in which location of corresponding objects exist respective base stations 211, 213, 215, for example, information including the second floor of Homeplus building, the ninth floor of Samsung building, and the first floor of NongHyup building to the portable terminal 100.

If the foregoing information about base stations 211, 213, and 215 based on augmented reality is provided to the portable terminal 100, the portable terminal 100 may output corresponding information on the display unit 140 as illustrated above. In this example, the display unit 140 of the portable terminal 100 may apply corresponding information to preview images collected by the image collecting sensor and output the preview images.

In the meantime, as illustrated in FIG. 6, when the portable terminal 100 user enters a certain building with gripping the portable terminal 100, the display unit 140 of the portable terminal 100 may display location information of a base station 220 located in the certain building as illustrated in FIG. 6. To do this, the information providing server 200 may produce building information of a located point of the portable terminal 100 and location information of the portable terminal 100 based on location information and altitude information of the portable terminal 100 to provide information about a point of the building in which the portable terminal 100 is located and location information of the base station 220 in the building to the portable terminal 100. Accordingly, the portable terminal 100 may output an image corresponding to a building shape, respective current locations of a portable terminal 100 and the base station 220 in a corresponding building to the display unit 140 based on information received from the information providing server 200. Accordingly, the user may easily recognize where to move a corresponding building to acquire a more excellent electric field situation based on information output on the display unit 140. As illustrated previously, the display unit 140 of the present disclosure may output a location and an altitude of the portable terminal 100 on a certain object among the augmented reality image information, and display a location and an altitude of at least one base station on a corresponding object among the augmented reality image information.

As illustrated earlier, if information of respective base stations 211, 213, 215, and 220 are output on the display unit 140 based on a 3D electric field information display mode, the portable terminal 100 user may recognize intuitively and in detail which point of a building that the user should move to acquire a more excellent electric field situation. In the meantime, when a direction of an image collecting sensor in the portable terminal 100 changes to photograph other objects, the information providing server 200 receives information about changed objects, and collects and provides information about base stations to the portable terminal 100 through the foregoing procedure. The foregoing embodiment has illustrated that forms of icons displaying respective base stations 211, 213, 215, and 220 are identical with each other. However, the present disclosure is not limited thereto. That is, as illustrated above, the forms of icons displaying respective base stations 211, 213, 215, and 220 may be changed according to characteristics of base stations.

Since there is a vast arithmetic processing amount of augmented reality data, a portable terminal 100 of the present disclosure may support a 3D electric field display mode in real time. However, when the user creates an input signal for setting a 3D electric field information display mode for a current point in a state that the electric field information display mode is firstly activated, information of the corresponding base stations 211, 213, 215, and 220 may be temporarily output. In this example, as shown in FIG. 4, the portable terminal 100 may output the 2D electric field information and the 3D electric field information on a separate pop-up window or a divided screen according to screen division. Conversely, the portable terminal 100 may output the 3D electric field information on a total screen or output the 2D electric field information on a pop-up window. That is, the portable terminal 100 of the present disclosure may output a screen displaying only 2D electric field information, a screen displaying only 3D electric field information, a screen displaying 3D electric field information based on the 2D electric field information, and a screen displaying 2D electric field information based on the 3D electric field information on the display unit 140 according to a user request or previous setting.

The foregoing embodiment has illustrated functions and roles of Respective structural elements of the system for displaying electric field information according to an embodiment of the present disclosure. Hereinafter, a method for display electric field information according to an operation of the portable terminal for supporting display of electric field information of the present disclosure will be described in detail.

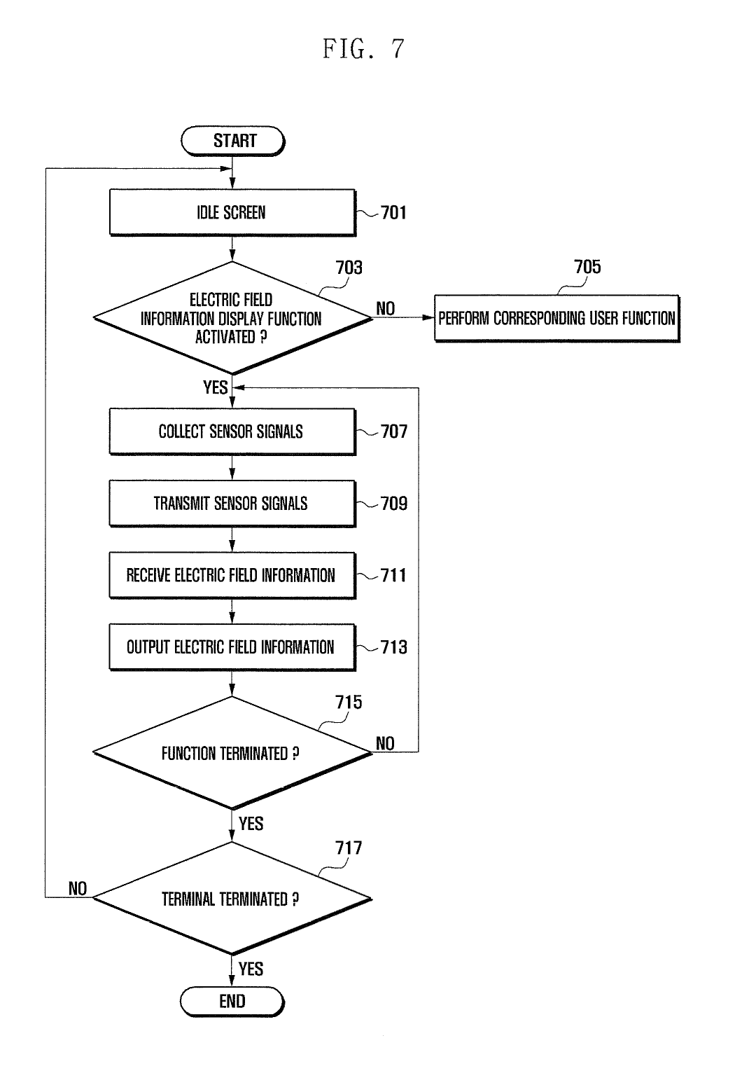

FIG. 7 illustrates a method for displaying electric field information according to the present disclosure.

Referring to FIG. 7, in the method for displaying electric field information of the present disclosure, if power is supplied to the portable terminal 100, a controller 160 may initialize respective structural elements of a portable terminal 100 using the supplied power and control the display unit 140 to output an idle screen according to preset schedule information in an initialization termination procedure (701).

Next, the controller 160 may determine whether an event for activating an electric field information display function occurs (703). That is, the controller 160 may determine whether activation of a user function requiring an electric field information display function is requested or an input signal for displaying electric field information is generated. When an input signal for activating the electric field display function is not generated, the controller 160 may perform a corresponding user function of the portable terminal 100 such as a file playback function, a file search function, a call function, and a web access function according to generation of the input signal (705).

If an event for activating the electric field information display function occurs at step 703, the controller 160 may perform a control operation to collect sensor signals (707). To do this, the controller 160 may perform a control operation to activate the sensor 170, that is, to activate certain sensors included in the sensor according to a current set electric field display mode. When a mode of the portable terminal is a 2D electric field information display mode, the controller 160 may perform a control operation to activate sensors for collecting location information and direction information and then to collect corresponding sensor signals. When a mode of the portable terminal is a 3D electric field information display mode, the controller 160 may perform a control operation to activate sensors for collecting location information, direction information, altitude information, and image information and then to collect corresponding sensor signals.

Subsequently, the controller 160 may perform a control operation to transmit the collected sensor signals to the information providing server 200 (709). In this example, the controller 160 may perform a control operation to create state information containing the collected sensor signals and transmit the created state information to the information providing server 200. Then, the controller 160 may receive electric field information from the information providing server 200 (711). When receiving the electric field information, the controller 160 may control the display unit 140 to output corresponding electric field information (713). The output of the electric field information may be at least one of display of the 2D electric field information and display of the 3D electric field information.

Next, the controller 160 may determine whether an input signal for terminating an electric field information display function indicating electric field intensities between the portable terminal 100 and peripheral base stations is generated (715). When the input signal for determining the function is not generated, the controller 160 returns to step 707 and performs the foregoing procedures during a predetermined time period.

While repeating step 707 to step 713, the controller 160 senses variation in moving speed of the portable terminal 100 based on the collected sensor signals from the sensor 170. When the moving speed of the portable terminal is increased, the controller 160 may make repetition periods of step 707 to step 713 shorter to increase the number of the repetition periods thereof. When the moving speed of the portable terminal is reduced, the controller 160 may make repetition periods of step 707 to step 713 longer to reduce the number of the repetition periods thereof.

Conversely, if an input signal for terminating the function is generated, the controller 160 terminates the electric field display function, and then checks generation of an input signal for terminating the portable terminal (717). If the input signal for terminating the function is not generated, the process returns to step 301 and the controller 160 may perform a control operation to repeat the foregoing procedures.

The foregoing portable terminal 100 may further include various additional modules according to provision forms. That is, when the portable terminal 100 is a communication terminal, it may include constructions that are not mentioned such as a camera module for photographing still images/moving images of a subject, an interface exchanging data in a wired communication scheme or a wireless communication scheme of the portable terminal 100, an Internet communication module communicating with an Internet to perform an Internet function, and a digital broadcasting module receiving and broadcasting digital broadcastings. Since the structural elements can be variously changed according to convergence trend of a digital device, no elements can be listed. However, the portable terminal 100 may include structural elements equivalent to the foregoing structural elements. Further, the terminal 100 of the present disclosure may be substituted by specific constructions in the foregoing arrangements according to the provided form or another structure. This can be easily understood to those skilled in the present art.

Further, the portable terminal 100 according to an embodiment of the present disclosure may include various types of device having a communication module capable of performing data communication. For example, the portable terminal 100 may include an information communication device and a multimedia device such as a Portable Multimedia Player (PMP), a digital broadcasting player, a Personal Digital Assistant (PDA), a music player (e.g., MP3 player), a portable game terminal, a Smart Phone, a notebook computer, and a handheld PC as well as various mobile communication terminals corresponding to various communication systems.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for displaying electric field information, the method comprising:
collecting a sensor signal including location information and direction information of a portable terminal;
transmitting the collected sensor signal to an information providing server by the portable terminal; and
receiving and outputting electric field information indicating an electric field intensity between the portable terminal and at least one base station located within a predetermined range of a direction in which the portable terminal is arranged among the at least one base station arranged around the portable terminal based on the sensor signal by the portable terminal.

2. The method of claim 1, wherein collecting a sensor signal comprises:
activating a location detection sensor and a direction detection sensor of the portable terminal when the portable terminal is set to a two-dimensional electric field information display mode; and
collecting the location information and the direction information through the activated location detection sensor and direction detection sensor.

3. The method of claim 2, wherein receiving and outputting the electric field information comprises:
outputting map information of a peripheral zone based on a current location of the portable terminal; and
displaying the current location and a moving direction of the portable terminal, and information including an electric field intensity between the portable terminal and at least one base station located in at least one of a peripheral zone of a moved path in the moving direction of the portable terminal and a peripheral zone of an expected moving path on the map information.

4. The method of claim 1, wherein collecting the sensor signal comprises:
activating a location detection sensor, a direction detection sensor, an altitude detection sensor, and an image collecting sensor of the portable terminal; and
further collecting altitude information and image information in addition to the location information and the direction information through the activated location detection sensor, direction detection sensor, altitude detection sensor, and image collecting sensor.

5. The method of claim 4, wherein transmitting the collected sensor signal comprises transmitting the altitude information and the image information to the information providing server in addition to the collected location information and the direction information, and
wherein the electric field information is three-dimensional electric field information generated based on augmented reality containing objects included in the image information in a located point of the portable terminal and at least one base station information based on the location information, the direction information, the altitude information, and the image information by the information providing server.

6. The method of claim 5, wherein receiving and outputting the electric field information comprises:
displaying an image of a direction in which an image detection sensor of the portable terminal is arranged among image information of a peripheral zone of a current location of the portable terminal based on the electric field information based on the augmented reality; and
displaying information of objects including at least one base station among the image based on the augmented reality and the information including the electric field intensity between the at least base station and the portable terminal.

7. The method of claim 6, wherein displaying information comprises at least one of:
outputting a location and an altitude of the portable terminal on a certain object among the image based on the augmented reality; and
displaying a location and an altitude of the at least one base station on a corresponding object among the image based on the augmented reality.

8. The method of claim 4, wherein receiving and outputting the electric field information comprises:
displaying two-dimensional electric field information based on the location information and the direction information;
dividing a two-dimensional electric field information display screen according to generation of an input signal; and
displaying three-dimensional electric field information being an image based on augmented reality based on the altitude information and the image information on a pop-up window output on the divided screen or the two-dimensional electric field information display screen.

9. The method of claim 1 further comprising:
detecting moving speed of the portable terminal, and
wherein collecting the sensor signal comprises controlling a collecting time of the sensor signal according to variation in the moving speed of the portable terminal.

10. A system for displaying electric field information, the system comprising:
an information providing server configured to generate at least one of:
two-dimensional electric field information indicating an electric field intensity between a portable terminal and at least one base station located within a predetermined range of a direction in which the portable terminal is arranged among the at least one base station arranged around the portable terminal based on a first sensor signal including location information and direction information received from the portable terminal, and
three-dimensional electric field information based on augmented reality indicating an electric field intensity between the at least one base station and the portable terminal based on a second sensor signal including the location information, the direction information, altitude information, and image information received from the portable terminal; and
the portable terminal configured to collect and transmit the first and second sensor signals to the information providing server, and receive and output at least one of the two-dimensional electric field information and the three-dimensional electric field information from the information providing server.

11. The system of claim 10, wherein the portable terminal comprises:
a sensor including at least one of a direction detecting sensor configured to detect the direction information, a location detection sensor configured to detect the location information, an altitude detection sensor configured to detect altitude information, and an image collecting sensor configured to collect the image information;
a radio frequency communication unit configured to exchange signals with the information providing server;
a display unit configured to output the electric field information; and
a controller configured to control transmission of the first and second sensor signals, and reception and output of the electric field information.

12. The system of claim 11 further comprising:
a memory configured to store map information of a peripheral zone based on a current location of the portable terminal,
wherein the display unit configured to display the current location of the portable terminal, a location of at least one base station located in a peripheral zone of a path moved in a moving direction of the portable terminal and a peripheral zone of an expected moving path, and an electric field intensity between the portable terminal and the at least one base station displayed on a zone neighboring a point on which the at least base station is displayed when displaying the two-dimensional electric field information.

13. The system of claim 11, wherein the display unit is further configured to display image information based on augmented reality of a direction in which the image detection sensor of the portable terminal is arranged among image information of a peripheral zone based on the current location of the portable terminal, information of objects including at least one base station among the image based on augmented reality, and information including an electric field intensity between the at least one base station and the portable terminal when displaying the three-dimensional electric field information.

14. The system of claim 13, wherein the display unit outputs the location and the altitude of the portable terminal and the location and the altitude of the at least one base station on a certain object among the image based on augmented reality.

15. The system of claim 11, wherein the sensor further comprises a speed detection sensor configured to detect a moving speed of the portable terminal, and
wherein the controller is further configured to control collecting times of the sensor signals of the sensor according to variation in the moving speed of the portable terminal.

16. A portable terminal supporting display of electric field information, the terminal comprising:
a sensor including a direction detection sensor configured to detect direction information and a location detection sensor configured to detect location information;
a radio frequency communication unit configured to transmit a sensor signal collected from the respective detection sensors to an information providing server, and receive two-dimensional electric field information indicating an electric field intensity between the portable terminal and at least one base station located in a predetermined range within an arranged direction of the portable terminal indicated by the direction information among at least one base station arranged around the portable terminal from the information providing server;
a display unit configured to display the current location of the portable terminal, a location of at least one base station located in a peripheral zone of a path moved in a moving direction of the portable terminal and a peripheral zone of an expected moving path, and an electric field intensity between the portable terminal and the at least one base station displayed on a zone neighboring a point on which the at least base station is displayed on map information of a peripheral zone based on the current location of the portable terminal; and
a controller configured to control transmission of the sensor signal, and reception and output of the electric field information.

17. The portable terminal of claim 16, wherein the sensor further comprises an altitude detection sensor configured to collect altitude information and an image collecting sensor configured to collect image information;
wherein the radio frequency communication unit is further configured to transmit the altitude information and the image information to the information providing server according to an input signal, and receive electric field information based on three-dimensional augmented reality including information of objects including at least one base station in an image included in image information based the location information, the direction information, the altitude information, and the image information of the portable terminal from the information providing server; and
wherein the display unit is further configured to display image information based on augmented reality of a direction in which the image detection sensor of the portable terminal is arranged among image information of a peripheral zone based on the current location of the portable terminal, and information of objects including at least one base station among the images based on augmented reality and information including an electric field intensity between the at least one base station and the portable terminal according to an input signal.

18. The portable terminal of claim 17, wherein the display unit is further configured to output the location and the altitude of the portable terminal and the location and the altitude of the at least one base station on a certain object among the image based on augmented reality.

19. The portable terminal of claim 17, wherein the display unit is further configured to display at least one of the two-dimensional electric field information and the three-dimensional electric field information on one screen.

20. The portable terminal of claim 16, wherein the sensor further comprises a speed detection sensor configured to detect a moving speed of the portable terminal, and
wherein the controller is further configured to control respective collecting times of the sensor signals of the sensor according to variation in the moving speed of the portable terminal.
